(19) United States
(12) Patent Application Publication
(10) Pub. No.: US 2025/0360669 A1
(43) Pub. Date: Nov. 27, 2025

(54) Method and apparatus for shaping plastic preforms into plastic containers, with machine regulation

(71) Applicant: KRONES AG, Neutraubling (DE)

(72) Inventors: Christian BETZ, Geigant (DE); Thomas HOELLRIEGL, Teublitz (DE); Konrad SENN, Alteglofsheim (DE); Dominik MEIER, Parsberg (DE); Benedikt HENGL, Essing (DE); Markus KULZER, Zell (DE); Daniel VOGLER, Neutraubling (DE); Stefan SERVE, Obergoßzell (DE)

(21) Appl. No.: 19/110,178

(22) PCT Filed: Aug. 21, 2023
(86) PCT No.: PCT/EP2023/072920

§ 371 Date: Mar. 10, 2025

(30) Foreign Application Priority Data
Sep. 8, 2022 (DE) 10 2022 122 881.9

(51) Int. Cl. B29C 49/78; B29C 49/36; B29L 31/00

(52) U.S. Cl. CPC B29C 49/783; B29C 49/36; B29C 2049/7833; B29C 2049/78805; B29L 2031/712

(57) ABSTRACT

A method and apparatus for shaping plastic preforms into plastic containers, wherein at least three different pressure stages are applied to the plastic preforms in order to expand them, wherein the pressure stages are provided by at least three different compressed-air reservoirs, and wherein, additionally, the plastic preforms are stretched in their longitudinal direction by stretching rods, wherein compressed air is returned at least at times from the plastic containers to at least one compressed-air reservoir, and at least one value characteristic of the consumption of compressed air is detected.

The present invention relates to a method and an apparatus for shaping plastic preforms into plastic containers. Such apparatuses and methods have long been known from the prior art. Heated plastic preforms are shaped into plastic containers and, in particular, plastic bottles by applying a flowable and, in particular, gaseous medium. This process has become increasingly complex over time. In addition to applying air, the plastic preforms are typically also stretched in their longitudinal direction by means of so-called stretching rods, which are inserted into the plastic preforms.

In the prior art, it is known that this shaping takes place with several compressed-air levels or with several pressures. It is common practice to first apply a pre-blowing pressure to the plastic preforms, then a higher intermediate blowing pressure and finally a final blowing pressure in order to fully form the container.

Recently, more and more efforts have been made to design such methods and apparatuses in a cost-and energy-efficient manner. In doing so, the consumption of compressed air is an important criterion.

During the application to the plastic preforms, a blowing curve is typically created. In blowing machines known from the applicant's internal prior art, this blowing curve is recorded but not evaluated. Rather, it is simply visualized for the user. The user can then set limit values, wherein responses are carried out, for example, a blowing process is aborted, when these limit values are exceeded or fallen below.

It is also known from the prior art that so-called compressed-air recycling is carried out to save compressed air. In this case, after the plastic containers have been formed, the high pressure in the containers is returned to compressed-air reservoirs at a lower compressed-air level.

In the prior art, the blowing process is primarily controlled via time points. For example, at a certain angle of a blowing wheel, the stretching rod is moved to a point PT 0 (the stretching rod is in contact with the plastic preform) and a blowing nozzle is placed on the plastic preform.

After this time point or around this time point, a pre-blowing valve is opened in a time-controlled manner and an adjustable pressure is applied to the plastic preform. Offset settings can be made for the different shaping stations in order to take into account any differences between the individual shaping stations or the different switching times of the pre-blowing valves.

This is important due to the very high influence on the material distribution of the time point “P1 opens” but may change over the years due to the wear and tear of the valves and is rarely readjusted after commissioning the machine.

For this purpose, it is known from EP 2 855 114 B1 to detect the time point P1 in the blowing curve (pressure in the cavity over time). More precisely, the time point at which the pressure build-up in the valve block could actually be measured by means of a pressure sensor and the control automatically adjusts the deviation from the target time point is detected.

The other valve switching points are controlled via time points. For example, the intermediate blowing valve is typically opened in the range of PT10 (stretching rod reaches base cup clearance) and the P2 valve with the final blowing pressure is opened after a certain time.

Once the P2 pressure has been successfully applied in the cavity/bottle, certain pressure fluctuations occur due to the dynamics of the incoming fluid and the fluctuations of the P2 annular channel of the blowing machine. From an energy point of view, it would make sense to close the P2 valve at one of the minima of the pressure fluctuations, since this generates a lower pressure in the bottle (closing the valve stops air from flowing back into the annular channel) and effectively results in lower air consumption.

However, this time point (P2 valve closes) is currently also still entered manually, and it may thus happen that, due to changed process parameters, the P2 valve no longer closes at the minimum and the air consumption is no longer at a minimum.

It would also make sense from an energy point of view to retract the

stretching rod only when the P2 valve is closed, since the displaced volume of the stretching rod also has a positive effect on air consumption. Currently, this time point is also set manually by the machine operator.

Air recycling is currently structured in such a manner that the machine operator sets certain limits. Within these limits, an automatic pressure-regulated regulation attempts to find an operating point at which the annular channel pressure can be kept constant with the help of air recovery. The limit values are set such that there are no detrimental effects on bottle quality and, at the same time, there is sufficient time for recycling.

In order to take into account effects such as the dynamic pressure of the fluid in the annular channel, the machine operator selects an offset of the pressure level after a short setting run without recycling angle. This offset can also change slightly over time and especially with different process parameters so that it may happen that non-optimal settings are used for certain recipes.

In addition, different dynamic pressure compensation could also be advantageous for different order quantities. In extensive investigations, the applicant has determined that the offset can deviate even more than assumed. The offset should change depending on the operating situation.

Within the scope of the invention, it is proposed to consider several, for example three, states. The individual value can be set or adjusted via the regulation. For reasons of simplification, however, three fixed values would also be conceivable.

The relief pressure is currently set indirectly via the relief time point when the blowing nozzle is removed. If a higher relief pressure is desired, later relief time points must be selected manually.

The prior-art methods and apparatuses have the disadvantage that a very high level of knowledge is required on the part of the machine operators in order to set the system optimally. In addition, compensation for deviations in some setting values is typically only possible manually.

There are also major difficulties in ensuring optimal air consumption. If additional blowing stages, such as an additional intermediate blowing stage, are provided for the methods, this also increases the probability of errors. In addition, pressure fluctuations, for example in a pre-blowing channel, cannot be adequately compensated. This makes it difficult to fully exploit the potential for increasing performance, in particular through higher relief pressure, and also results in a high probability of errors.

A further disadvantage of known machines is that the efficiency of air recovery or compressed-air consumption is not displayed to the user. In addition, statements about air consumption are only possible in conjunction with an integrated flow meter. This means that the effectiveness or efficiency of a production program, in particular with regard to air consumption, cannot be verified directly.

Since the blowing process is substantially defined by time points set by an operator, further problems arise. While some points are particularly important in terms of process engineering and therefore still have to be specified manually, there are also points that have a lower priority in terms of process engineering but may be relevant for optimal compressed-air consumption in particular. So far, it has not been possible to optimally exploit the compressed-air consumption potential.

In the prior art, there is no formula for an optimal blowing process. As mentioned above, additional intermediate blowing stages, in particular air recovery and the resulting effects, also increase the effort required to find an optimal blowing process enormously.

The present invention is therefore based on the object of making such methods and apparatuses for shaping plastic preforms into plastic containers more efficient. According to the invention, these objects are achieved by the subject matter of the independent claims. Advantageous embodiments and developments are the subject matter of the dependent claims.

In a method for shaping plastic preforms into plastic containers according to the invention, a transport device transports the plastic preforms along a specified transport path, wherein the transport device has a preferably rotatable transport support, on which a plurality of shaping stations is arranged. These shaping stations each have blow molding devices, within which the plastic preforms are shaped into the plastic containers by applying a flowable and in particular gaseous medium and in particular compressed air (in particular by means of an application device such as a blowing nozzle), and wherein at least three different pressure stages (and/or pressure levels) are applied to the plastic preforms in order to expand them, wherein these pressure stages are provided by at least three different compressed-air reservoirs. Furthermore, the plastic preforms are stretched in their longitudinal direction by means of stretching rods.

According to the invention, compressed air is returned at least at times from the shaping stations and/or the blow molding devices and/or the containers to a compressed-air reservoir and at least one consumption of compressed air is detected.

It is therefore proposed within the scope of the invention that, on the one hand, compressed air is returned to the reservoirs and, on the other hand, a compressed-air consumption and/or at least one value characteristic of a compressed-air consumption is also detected.

The characteristic value is preferably a measured (mass or volume) flow rate, a current relief pressure or a difference between the highest intermediate blowing pressure and the final blowing pressure.

Particularly preferably, for expanding the plastic preforms, a pre-blowing pressure is applied to them first, then at least one intermediate blowing pressure and finally a final blowing pressure. The intermediate blowing pressure is preferably higher than the pre-blowing pressure, and the final blowing pressure is higher than the intermediate blowing pressure. Particularly preferably, the aforementioned compressed-air levels are applied one after the other to each plastic preform.

Preferably, after the final blowing pressure has been applied, (pressure) relieving of the now formed plastic container is again carried out, wherein this is again preferably carried out in the compressed-air channels or compressed-air reservoirs mentioned.

Preferably, this returning of compressed air, also known as recycling, takes place in at least two compressed-air reservoirs.

Particularly preferably, the compressed-air reservoirs are annular channels, which are particularly preferably arranged on the support on which the shaping stations are also arranged.

Particularly preferably, the compressed-air reservoirs are fed by a rotary distributor, which distributes the air from a stationary compressed-air reservoir and/or pressure connection and/or compressor to the transport support and in particular to the individual reservoirs.

The compressed-air reservoirs mentioned particularly preferably supply all shaping stations. For this purpose, a plurality of line connections, which connect the compressed-air reservoirs to the individual shaping stations, can be provided.

The air consumption of a shaping device, in particular a blowing machine and in particular a stretch blowing machine, can be determined in a first approximation by a formula (container volume+dead space)×current relief pressure×target output or by a formula (container volume+dead space)×(final blowing pressure−highest intermediate blowing pressure)×target output. This applies in particular to standard machines and not to so-called heatset machines, in particular if P1 and the intermediate blowing pressures are largely recycled.

Active air recovery reduces this relief pressure. The lower the relief pressure, the lower the total air consumption. It is not easy to say what the final relief pressure will be, since this final relief pressure depends on a number of factors, such as the level of the P2 pressure, the level of the P1 pressure, a duration of applying an intermediate blowing pressure (Pi1, Pi2), a container volume, an offset of the P1 pressure and an offset of the Pi1, Pi2 pressure, a regulation behavior and the like.

Within the scope of the present invention, the pre-blowing pressure is designated as P1, the final blowing pressure as P2 and a first intermediate blowing pressure as Pi1. Any second intermediate blowing pressure used is designated as Pi2. Preferably, further intermediate blowing pressures Pi3, Pi4, etc. can also be present.

In a preferred method, the invention makes use of existing measured values to calculate a recycling potential and/or measured values detected at earlier time points are used to determine machine parameters in such a manner that compressed-air consumption is minimized.

Thus, the maximum air consumption is advantageously equivalent to a relief level at the level of the pressure P2. A current air consumption should be determined via the measured values of a pressure transducer, in particular at the relief time point (i.e., the time point at which the container is relieved again after the final blowing). The difference between the two values results in an (absolute) air saving. The ratio of the two values results in a percentage recovery.

One difficulty is the manner in which the relief pressure is determined. As described in more detail below, this can be done, for example, by evaluating the blowing curve, possibly by means of a curve discussion of the blowing curve. However, this requires relatively high computing power.

In addition, the instantaneous value at a time point of switching a relief valve would also be conceivable, i.e., in particular, the instantaneous value of a pressure is recorded at the time point when a relief valve, which relieves compressed air from the container again, is measured.

In a preferred method, at least one pressure, in particular a pressure of the flowable medium, in particular of the compressed air in the container, is therefore determined at a specified time point, in particular a time point at which a valve which relieves the pressure in the plastic container is opened.

One advantage of the invention described here is an improved determination of the pressure levels and of the compressed-air consumption and thus a better adjustability of the machine.

Preferably, no further measuring devices or assemblies are required for this purpose. With a correspondingly good informative value, it would even be conceivable to dispense with a flow meter, which is sometimes provided in the prior art.

In a preferred method, leakages are detected by means of statistical methods. It would thus be possible, for example, for smaller leakages or basic turnover per platform size to be captured statistically and preferably included as a calculation factor.

In a preferred method, an air recovery system of the apparatus is optimized, in particular in addition to the visualization of air consumption and/or recycling potential. This is preferably done by means of a regulation device, in particular an internal machine regulation device, which preferably optimizes the air recovery system using the relief pressure, in particular by selecting suitable working parameters. In this manner, the best possible total air consumption can be achieved.

This would be possible either via a complex calculation model or via a learning loop by varying individual (working) parameters or a combination of both.

However, in this procedure, it is preferable to set and/or take into account limit values that are also not exceeded or fallen below by the regulation.

In this context, the regulation limits are important in order to avoid impairing the bottle quality too much. There are parameters, type-2 process parameters, that influence air consumption, e.g., a duration of air recovery Pi1, Pi2, but have little effect on bottle quality. However, there are also parameters, type-1 process parameters, that could have a significant influence on quality, e.g., a duration of applying the pressure Pi1 or a target pressure of Pi1 and P2.

In one embodiment, it is assumed that the operator sets the type-1 process parameters, which are decisive for the bottle quality. Type-1 process parameters are, for example, a target time-path curve of a stretching rod until complete stretching, a time point at which a pre-blowing valve P1 opens, a throttle cross-section of P1 and a target pressure in the pressure reservoir of P1, a closing time point of P1 or the time point at which the valve of the next higher pressure level opens and a final blowing pressure P2, and/or a time point when P2 is to be reached.

In a further embodiment, the number of values to be entered by the operator can be reduced even further if the two values of the throttle cross-section and of the target pressure of P1 are combined and reduced to a single value characterizing the volume or mass flow.

The type-1 process parameters basically determine a course of a blowing curve in FIG. 3 for a given preform (dimensions, temperature profile and material properties), stretching rod (dimensions) and blowing mold (dimensions, material and temperature) up to and including time point II as well as the pressure at time point IV.

It is also conceivable to specify the so-called P90 time or P90 pressure instead of the final blowing pressure P2 and the time point of reaching P2; this time and pressure indicate when 90% of the P2 pressure has been reached, and the P2 pressure and time point are then calculated or result therefrom.

The time from time point II in FIG. 3, the time point at which the valve of the next higher pressure stage after pre-blowing opens, to the time point at which P2 is reached (in some cases also just P90) is called the pressure rise time point and/or pressure build-up time of P2.

The course of a blowing curve can preferably also be defined by individual parameters of the type-1 process parameters mentioned above.

Preferably, the course of a blowing curve can also be defined by any combination of the type-1 process parameters mentioned above.

However, in order to define a complete pressure course of a blowing curve and thus the complete forming process, further parameters are necessary. These parameters typically only have a subordinate influence on the container quality and are referred to as type-2 process parameters. Type-2 process parameters are, for example, the time points at which the intermediate pressure valves Pi1-Pin and P2 open and/or close and/or the pressure levels of the intermediate blow pressures during pressure build-up and/or the time points at which the intermediate pressure valves, a P1 valve and a relief valve open and close.

The pressure course of a blowing curve and thus the complete forming process can preferably also be defined by individual parameters of the type-2 process parameters mentioned above.

Preferably, the pressure course of a blowing curve and thus the complete forming process can also be defined by any combination of the type-2 process parameters mentioned above.

In a preferred embodiment, after the type-1 process parameters have been entered, the apparatus or machine preferably suggests the type-2 process parameters to the operator.

In a further preferred embodiment, the type-2 process parameters are determined and/or set in part or completely by the machine.

Particularly preferably, the machine determines type-2 process parameters in such a manner that certain process parameters are associated with one another.

For example, during pressure build-up, the time point at which a first valve closes can be almost identical to the time point at which a second valve closes. Only the switching delays, from applying the electrical switching signal including any bus runtimes via the response time of the pilot, the pressure build-up in the main valve up to the movement of the main valve.

In a further preferred embodiment, the type-1 and/or type-2 parameters are determined on the basis of a model with or without AI (artificial intelligence) and/or the type-1 and/or type-2 parameters are determined by regulation or iteratively.

Depending on the application and the technical expertise, the system should or may therefore preferably only change certain control variables and/or type-2 process parameters independently, and preferably only within specified ranges.

This means that the “common” machine operator can carry out optimization at least at a “moderate” level with the greatest possible process reliability, while the experienced user may also be able to achieve greater savings through clever process control and more extensive regulation interventions in the type-2 process parameters. Ideally, however, the operator is spared the manual adjustment of the air recovery so that they can concentrate fully on the actual heating and blowing process and the container quality.

In a preferred embodiment, a display of the recycling potential and/or the air consumption and/or a number characteristic of the air consumption allows the machine operator to quickly recognize how efficiently an air recovery is set. This allows the machine operator to be made aware of the influencing parameters P2 and the bottle volume for the achievable air consumption or the recycling rate.

In addition, the present invention describes methods and measures to reduce pressure fluctuations in one of the pressure reservoirs and in particular also in a P1 pressure reservoir, to reduce air consumption by means of regulations and in particular automated regulations, and optionally also to increase the P2 (this is typically the highest pressure) holding time. In addition, higher output rates in terms of process engineering are to be realized and possible regulations for a simpler process.

The invention is therefore divided into different time points and describes possible measures at these time points in order to implement the stated objectives in the best possible way. This is explained in more detail with reference to the figures. Particularly preferably, an evaluation of the blowing curve evaluation, for example by software, is advantageous for a plurality of the ideas described here.

In a preferred method, a pressure course is recorded during the production of the plastic container and, particularly preferably, this pressure course is evaluated. For the evaluation, a curve discussion of this pressure course can be carried out, for example.

Preferably, the expansion of the plastic preforms is understood to mean the entire process, i.e., also a final blowing of the containers at a pressure P2. In particular, the pressure course is a course determined over time. Preferably, an evaluation is carried out by means of an algorithm and/or software. In doing so, information which allows improved control or regulation of the apparatus can be derived from the pressure course.

Particularly preferably, at least one working parameter, in particular a type-2 working parameter, for the expansion of the plastic preforms and/or for pressure build-up and/or recycling is changed on the basis of the evaluation of the pressure course, in particular in order to reduce the consumption of compressed air. Particularly preferably, this change in the working parameter is carried out automatically and/or by a regulation device of the machine.

Particularly preferably, certain working parameters, in particular blowing parameters, in particular type-2 process parameters, are generated (fully) automatically, wherein a corresponding apparatus preferably always finds the best possible compromise, in particular between partially conflicting objectives.

One of the objectives is, for example, to keep the relief pressure or the air consumption to a minimum. A further objective is to keep the high-pressure phase, i.e., the phases in which the final blowing pressure is applied, as long as possible. A high-pressure phase is understood to mean applying a pressure of more than 5 bar, preferably more than 10 bar, preferably more than 15 bar and preferably a pressure at the above-mentioned P2 pressure level to the plastic preforms.

A further possible objective is to minimize the pressure build-up time, i.e., the time from an end of a pressure P1 until a pressure P2 or its end is reached.

Particularly preferably, the working parameter mentioned is selected from a group of working parameters which includes a pressure build-up time of a pressure level, in particular an intermediate blowing pressure level Pi1, a distribution of a pressure build-up time (in particular a proportion of the pressure build-up time for a pressure P1 and the pressure build-up time for a pressure P2), a ratio between a recycling time and a pressure build-up time, a distribution of recycling stages, a distribution of the recycling time, in particular for the pressure stages Pi1 and Pi2), a start of a stretching process, an end of a stretching process, a stretching speed, a throttling speed of a valve device, in particular a pre-blowing valve, a time point at which valve devices open and/or close, in particular a P2 valve device, a target pressure of a pressure level, a time point for retracting the stretching rod or the like.

It is also possible to deactivate individual optional method steps. For example, the pressure recycling stages can be operated synchronously or asynchronously. It would also be conceivable to deactivate individual recycling stages.

What these parameters have in common is their multidimensional dependency and interactions. In addition, a change influences the three essential objective functions mentioned above to varying degrees.

It is therefore preferable to use a model that can be created on the basis of the interdependencies in the system.

Artificial intelligence (AI) is particularly preferably used for generating this model. Using a large amount of recorded data, it is possible to determine what effect a change in a particular parameter has on other parameters and also with regard to the objectives mentioned above. On the basis of these determinations, working parameters can be adjusted.

In a preferred method, this solution is found using mathematical and/or technical approaches. For example, it is possible to systematically run through a certain parameter field, for example by means of a DoE (design of experiments), and to carry out an evaluation of the parameter field, in particular with subsequent multi-dimensional optimization. For example, linear regression methods can be used here.

Particularly preferably, AI algorithms are also used.

In a further preferred method, iteration loops and in particular multi-stage iteration loops are used. Here, for example, individual values can be partially varied during operation and their effect on the target values analyzed. Optimal points can then be selected based on predefined rules and/or algorithms, for example PID controllers.

In a further preferred method, a calculation is carried out using a (complex) physical model.

In a preferred method, AI models, physical models or optimization methods are used, which take place, for example, in the machine control or externally, for example in a cloud-based manner in a computing environment provided for this purpose.

Once the solution has been found, it is possible to either apply it directly or at least display it to the user as an input suggestion and/or at least suggest a possible direction of movement to the user in order to better achieve one or more of these objectives.

In a further preferred method, it may also be possible to recommend a P2 pressure increase as a by-product of finding a solution if, for example, the pressure increase results in the air consumption remaining the same. In addition, a proposal to change a P1 pressure would also be possible if this results in process-related advantages and the pressure consumption or air consumption also remains substantially the same.

In a further preferred method, that least four different pressure levels are applied to the plastic preforms. In this method, a pre-blowing at a first pressure P1 takes place first. This is followed by two intermediate blowing steps at pressure levels Pi1 and Pi2 and finally a final blowing at the highest pressure P2. In this manner, the recycling potential can be increased, and the difference between P2 and the relief pressure can thus be increased further.

In a further preferred method, at least one value characteristic of a compressed-air consumption and/or a compressed-air course is visualized. For example, a display device such as a monitor can be used to output the pressure course, in particular including limit values, and a user can thus very quickly check the efficiency of the control.

In a further preferred method, the manufactured plastic containers are inspected. It is also possible to incorporate the data from this inspection into the machine control. For example, a change in certain parameters can result in a detrimental development of the plastic containers. Priority is given to creating the exact container desired. In this manner, it is also possible to check changes to working parameters made by a control against the target quality of the manufactured containers.

Preferably, a measurement of the wall thickness of the plastic containers is carried out as part of the inspection. Preferably, the wall thickness of the plastic preforms is measured in several regions of the manufactured plastic containers. In a further preferred method, the transparency and/or crystallinity and/or optical change in the wall of the plastic container is measured by cold stretching. In a further preferred method, mechanical properties such as top load or burst pressure are measured.

Particularly preferably, the plastic preforms are inspected without contact and/or optically.

In a further preferred method, a start time point of a stretching process is adjusted and/or changed. Preferably, a pre-blowing pressure is applied to the plastic preform and (at least at times) carried out simultaneously.

It is known from the prior art to change the start time of the P1 valve depending on a switching time difference of the valve devices. Within the scope of the present invention, it is now proposed to change the start time point of the stretching.

Preferably, if there are certain deviations in the pressure course at a specified point on the pressure curve, the stretching start is adjusted such that there is a constant time between a pressure build-up and the blowing curve and the stretching start. In particular, across all shaping stations.

This time is preferably set by the machine operator for one station and adopted for all stations! Deviations due to different switching times between the stations are preferably compensated via a modified stretching start.

Alternatively, it would be possible to monitor a current stretching position or a position of a stretching rod at a time point of a pressure increase, in particular a P1 pressure increase, and preferably to regulate the stretching start, i.e., the start of the stretching process.

This ensures that, at each station, the valve opens at the same position, speed and acceleration of the stretching rod in the plastic preform.

It would also be conceivable to change the stretching speed or acceleration of the stretching rod up to this time point in order to achieve this objective. However, it should be ensured that the stretching speed at the time point “tP1 opens” is constant across all shaping stations.

In a preferred method, an application device, such as a blowing nozzle in particular, is placed on a mouth of the plastic preforms in order to apply compressed air to them.

Preferably, the movement of this application device is decoupled from the movement of the stretching rod. It is thus possible for different drive devices to be provided for the movement of the application device and the movement of the stretching rod.

Furthermore, it would be possible to use a position of the stretching rod as a reference variable for the individual movements and/or the determination of the process parameters, for example to specify in mm or in % a stretching that the stretching rod has already performed from a time point P0 and/or at the start of the pre-blowing process.

In this case, the position of the stretching rod is preferably used as the control variable, which means that the interaction between the stretching rod movement and/or stretching rod position and the pre-blowing start can be better taken into account.

The present invention is furthermore aimed at an apparatus for shaping plastic preforms into plastic containers, comprising a transport device, which transports the plastic preforms to be shaped along a specified transport path, wherein the transport device has a preferably rotatable transport support, on which a plurality of shaping stations is arranged, wherein these shaping stations each have blow molding devices, within which the plastic preforms can be shaped into the plastic containers by applying a flowable and in particular gaseous medium, and the shaping stations each have application devices in order to apply the flowable medium to the plastic preforms, wherein the shaping stations each have stretching devices for stretching the plastic preforms in their longitudinal direction, and these stretching devices each have at least one stretching rod, which is movable in the longitudinal direction of the plastic preforms and which can be inserted into the plastic preforms, and wherein the apparatus has at least three compressed-air reservoirs in order to apply at least three different pressure levels to the plastic preforms.

According to the invention, compressed air can be returned at least at times from the shaping stations and/or the plastic containers to at least one compressed-air reservoir, and a detection device, which detects, at least at times, a value characteristic of the consumption of compressed air, is provided.

It is therefore also proposed in terms of the method to return compressed air from the shaping stations and, in particular, the containers to a further pressure reservoir and also to detect a compressed-air consumption or a value characteristic thereof by means of a detection device.

In a preferred embodiment, the apparatus has a control device, which controls the apparatus taking into account a detected consumption of compressed air. In particular, the control device controls valve devices of the individual shaping stations, stretching units of the individual shaping stations and the like. For example, time points and periods at which the individual pressure stages are applied to the plastic preforms can be controlled.

In a further preferred embodiment, the control device is suitable and intended to change working parameters for the shaping process and, in particular, to change them taking into account a detected consumption of compressed air. Preferably, these working parameters can be changed within specified limit values.

Particularly preferably, the apparatus has a plurality of measuring devices, which are suitable and intended to detect parameters or values which are characteristic of compressed-air consumption. For example, one or more flow measuring devices can be provided, which can be used to measure a flow rate of compressed air. For example, a flow rate between a reservoir and the individual shaping stations can be measured, or a flow rate of compressed air that is fed to the containers or plastic preforms.

In a preferred embodiment, a plurality of pressure measuring devices is also provided. For example, each shaping station can be assigned such a pressure measuring device. Such pressure measuring devices can also be assigned to the above-mentioned reservoirs.

In a preferred embodiment, at least one of the compressed-air reservoirs has a larger holding volume for compressed air than at least one further and preferably the other compressed-air reservoirs.

Furthermore, it is possible that at least two compressed-air reservoirs that can be brought into direct flow connection with one another are available, in particular for a specific pressure level.

In particular, this is the compressed-air reservoir for the first pressure P1 or the pre-blowing pressure.

Preferably, the holding volume of this compressed-air reservoir is at least 26%, preferably at least 30%, preferably at least 40% and preferably at least 50% greater than the holding volume of the other compressed-air reservoirs.

In order to reduce pressure fluctuations, a larger compressed-air reservoir may be provided or, alternatively, an additional annular channel or a volume with a downstream throttle or connection. In this manner, a larger reservoir volume or annular channel volume can be created.

The aim of this idea is that the compressed-air reservoir, i.e., in particular the annular channel, is used as a kind of compressed-air storage and that, due to an increased volume, smaller flow differences of the receiving stations or cavities have less influence on the pressure within the reservoir. The increased volume also smooths out differences.

In addition, this pressure fluctuation could also be reduced by an additional P1 annular channel and in particular a P1 compressed-air reservoir combined with a connecting line, preferably also with an adjustable throttle. For example, an additional reservoir, in particular an additional annular channel, could be provided, which has a connection to a main channel, preferably with the shaping stations and in particular with each shaping station. In this manner, air would be added again immediately at every point where air is being removed.

If such a connection is only provided at one point, for example with a throttle, then in the worst case air is in motion over an arc of 180°.

Such a larger reservoir or an additional reservoir can be arranged at different points of the apparatus but in particular in flow connection with the second or with the actual reservoir for compressed air.

In a further preferred embodiment, it is possible for smaller pressure differences to be filled or released through the additional annular channel described, in particular without the need to open a dome pressure valve, which introduces increased pressure fluctuations into the annular channel.

In a further preferred embodiment, the apparatus has a control device, which controls at least one process parameter on the basis of the measured pressure courses. In particular, this control device can also make use of artificial intelligence to effect this control.

In a further preferred embodiment, the control device is suitable and intended to change movement parameters of the stretching rod and, in particular, a speed of the stretching rod movement.

In a further preferred embodiment, the control device is suitable and intended to change a flow rate of the blowing air between at least one compressed-air reservoir and the individual shaping stations, in particular a flow rate of the blowing air between the P1 compressed-air reservoir and the individual shaping stations. Preferably, the apparatus has at least one and preferably several throttling devices, by means of which the flow rate can be changed.

If the stretching speed and/or the stretching acceleration were increased and the P1 flow rate were also increased at the same time, it would be possible to ensure the same amount of air in a shorter time point with the same stretching in the longitudinal direction and thus to have more P2 holding time.

However, it would also be conceivable to reduce the speed of the stretching rod movement, since a lower P1 pressure also makes lower air consumption possible.

Preferably, the maximum speed of the stretching rod is more than 1.0 m/s, preferably more than 1.5 m/s, preferably more than 2.0 m/s, preferably more than 2.5 m/s. Preferably, the stretching units have electromotive drive devices and, in particular, linear motors for moving the stretching rods.

Preferably, the maximum stretching rod acceleration is more than 40 m/s², preferably more than 45 m/s², preferably more than 50 m/s².

Preferably, the control device makes it possible to control working and/or process parameters that affect the P1 compressed-air reservoir and/or the supply of the shaping stations by the P1 compressed-air reservoir. Preferably, independent control of the process parameters for the lowest possible air consumption and the lowest possible P1 pressure reservoir fluctuations is also achieved in this manner.

Preferably, it is possible here to change working parameters that are selected from a group of working parameters which includes an intermediate blowing pressure or its level, an intermediate blowing time (for a specified number but at least one intermediate pressure level), a recycling duration of a pre-blowing pressure, a pre-blowing recycling time point (this is relevant in particular for the pressure fluctuations), a recycling duration of an intermediate blowing pressure, a time point for closing a final blowing (P2) valve, or a time point for a return stroke of the stretching rod from a P10 position, i.e., the position in which the stretching rod is extended into the base cup of a blowing mold and/or contacts the top of the plastic preform.

Valve overlap times can also be changed.

These changes are based on several considerations:

The applicant has determined that a pressure level between the final blowing pressure and the pre-blowing pressure effectively reduces compressed-air consumption. Advantageously, so-called intermediate blowing pressure at a pressure level between 30% and 70%, preferably between 40% and 60% of the final blowing pressure is used for this purpose.

Preferably, a further intermediate pressure is added between the intermediate blowing pressure level and the final blowing pressure level. This makes the relationship between the individual pressure levels and the air consumption complex and there is no longer a functioning ballpark figure.

Even now, there are already process points where the above specification of the intermediate blowing pressure does not result in the ideal air consumption and additional costs arise due to a higher compressed-air requirement!

It has also been shown that lower P1 pressure levels are more efficient in terms of air consumption. However, lower P1 pressure levels increase the influence of any fluctuations in the annular channel pressure and can lead to poorer process stability.

Preferably, each station on a rotary machine feeds air into the annular channel during air recycling and requires air from the annular channel during the molding process. The annular channel is preferably a circumferential channel, on which several stations are preferably arranged and connected with approximately the same line length. However, the annular channel does not necessarily have to be designed as a ring, so that a central distributor or a central volume with distributor can also be used.

By carefully selecting the time management of the return feed, peaks in the pressure course in the annular channel can be absorbed and the fluctuation reduced.

Further advantages and embodiments emerge from the accompanying drawings, in which:

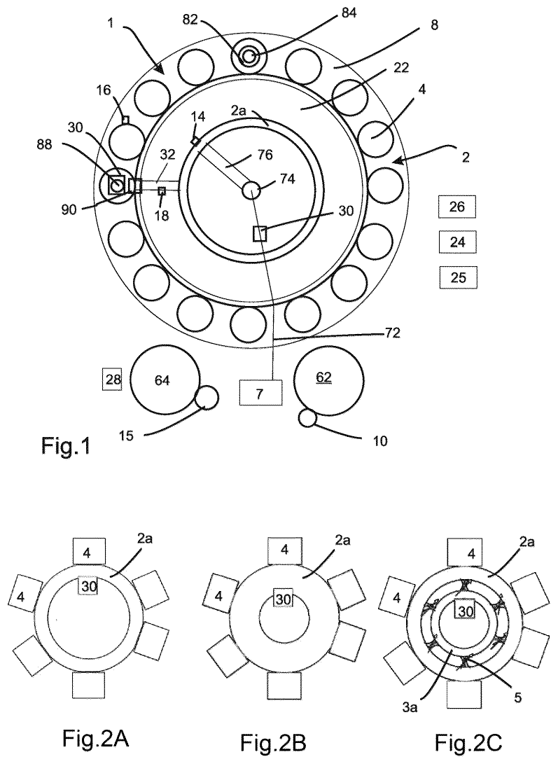

FIG. 1 is a schematic representation of an apparatus according to the invention;

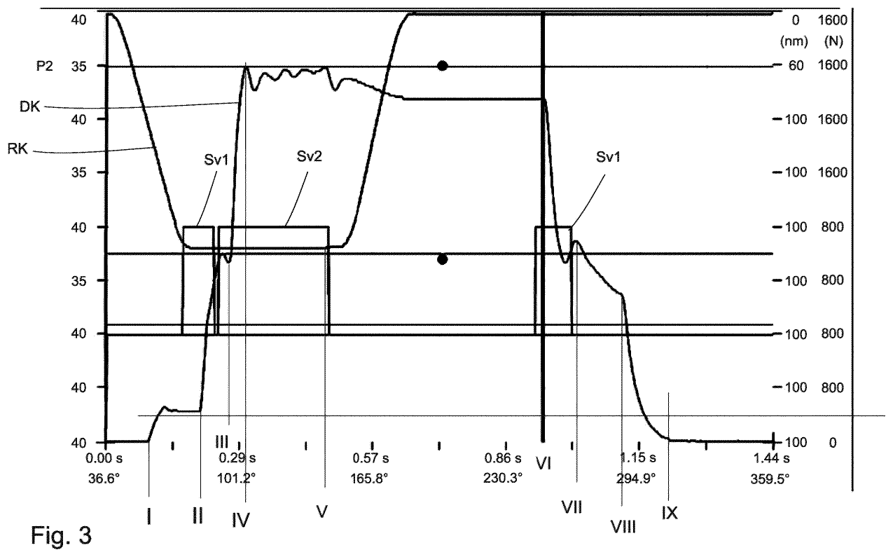

FIG. 2a-c are three representations illustrating an enlarged compressed-air reservoir;

FIG. 3 is a representation of a pressure curve;

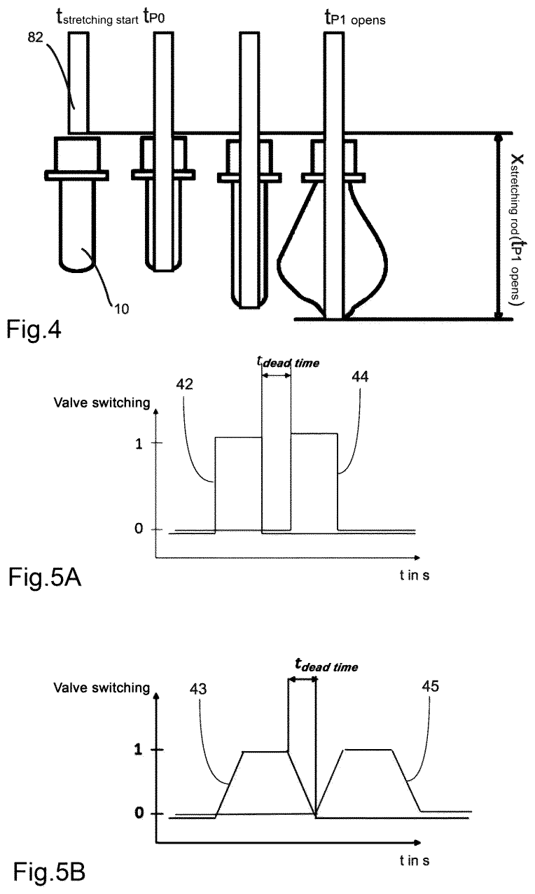

FIG. 4 is a representation illustrating a stretching rod movement;

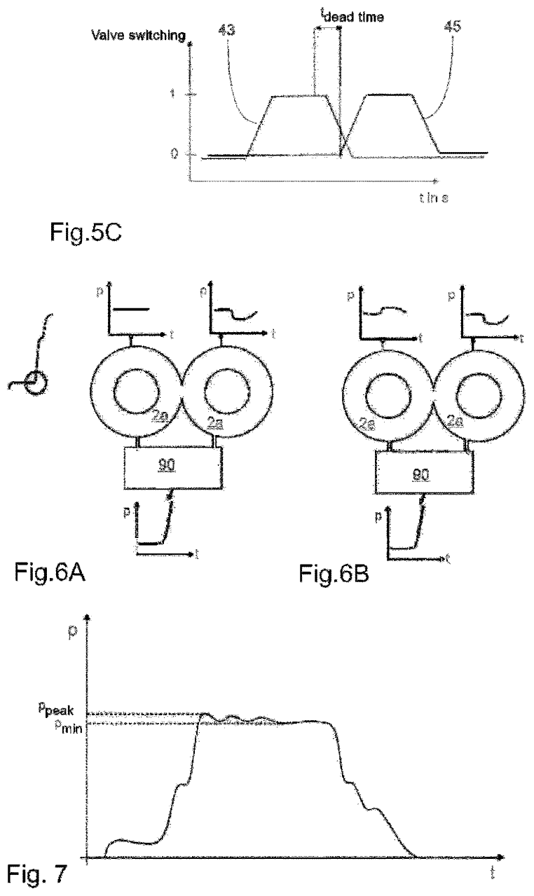

FIG. 5a-c are three representations illustrating valve switching time points;

FIG. 6a,b are two representations illustrating a valve control;

FIG. 7 is a pressure course;

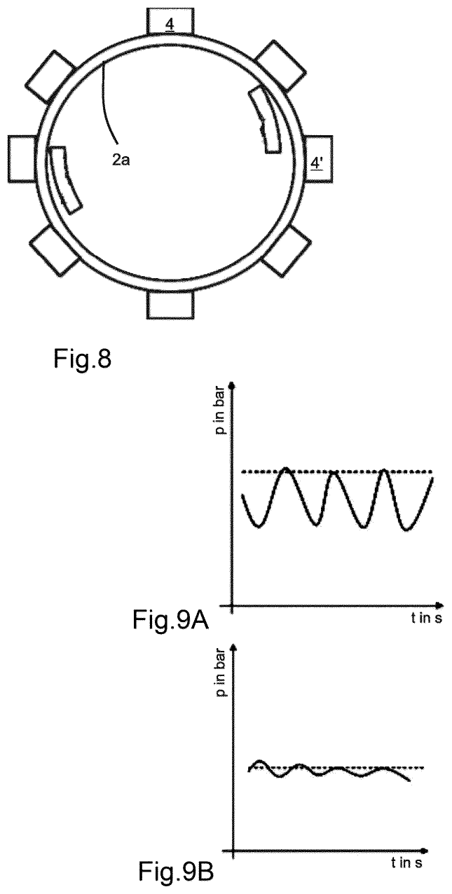

FIG. 8 is a representation illustrating switching time points; and

FIG. 9a,b are pressure courses during recycling.

FIG. 1 shows an apparatus 1 for shaping plastic preforms 10 into plastic containers 15. This apparatus has a rotatable support 22, on which a plurality of shaping stations 4 is arranged. These individual shaping stations each have blow molding devices 82, which in their interior form a cavity for expanding the plastic preforms.

Reference sign 84 designates an application device, which is used to expand the plastic preforms 10. This may, for example, be a blowing nozzle, which can be placed on a mouth of the plastic preforms in order to expand them. It would also be conceivable for the blowing nozzle to seal against the blow molding device. Preferably, this application device is movable in a longitudinal direction and preferably exclusively in a longitudinal direction of the plastics material preforms.

Reference sign 90 designates a valve arrangement, such as a valve block, which preferably has a plurality of valves, which control the application of different pressure levels to the plastic preforms. Preferably, each shaping station has such a valve block.

In a preferred method, a pre-blowing pressure P1 is applied to the plastic preforms first, then at least one intermediate blowing pressure Pi1 or Pi2, which is higher than the pre-blowing pressure, and finally a final blowing pressure P2, which is higher than the intermediate blowing pressure Pi1 or Pi2. After the plastic containers have expanded, the pressures or the compressed air are preferably returned from the container to the individual pressure reservoirs. Preferably, a further pressure stage, in particular a further intermediate blowing pressure, is provided.

Reference sign 88 designates a stretching rod, which is used to stretch the plastic preforms in their longitudinal direction. Preferably, all shaping stations have such blowing molds 82 as well as stretching rods 88. This stretching rod is preferably a component of a stretching device designated as 30. The stretching rod is (preferably also exclusively) movable in the longitudinal direction of the plastic preforms 10.

Preferably, the number of such shaping stations 4 is between 2 and 100, preferably between 4 and 60, preferably between 6 and 40.

The plastic preforms 10 are fed to the apparatus via a first transport device 62 such as, in particular but not exclusively, a transport star. The plastics containers 15 are transported away via a second transport device 64.

Reference sign 7 designates a pressure supply device, such as a compressor or also a compressed-air connection. The compressed air is conveyed via a connecting line 72 to a rotary distributor 74 and from there passed on via an additional line 76 to the compressed-air reservoir 2a, which in this case is an annular channel. Thus, preferably, such rotary distributor serves the purpose of feeding air from a stationary part of the apparatus into a rotating part of the apparatus.

In addition to this illustrated annular channel 2a, further annular channels are preferably provided, which are however hidden by the annular channel 2a in the representation shown in FIG. 1, for example due to lying underneath it. Reference sign 32 designates a connecting line, which delivers the compressed air to a shaping station 4 or its valve block 90. Preferably, each of the annular channels is connected to all shaping stations via corresponding connecting lines. This connecting line is preferably arranged in the rotating part of the apparatus.

Reference sign 8 schematically designates an optional clean room, which is preferably formed here in the shape of a ring and surrounds the transport path of the plastic preforms 10. Preferably, a (geometric) axis of rotation with respect to which the transport support 22 is rotatable is arranged outside the clean room 8. Preferably, the clean room is sealed from the non-sterile environment by a sealing device, which preferably has at least two water locks.

Furthermore, the apparatus has a cover device (not shown in FIG. 1), which delimits the clean room 8 upward. This cover device is preferably arranged on at least one of the stretching devices 30.

The apparatus has a plurality of measuring and/or sensor devices, which are used to control the apparatus. Reference sign 14 designates a pressure measuring device, which measures an air pressure within the compressed-air reservoir 2a. Preferably, the other compressed-air reservoirs also have corresponding pressure measuring devices.

Reference sign 16 designates a further pressure measuring device, which measures an air pressure, in particular an internal container pressure of the plastic preform to be expanded. Preferably, such a pressure measuring device is assigned to each shaping station.

Reference sign 18 also schematically designates a flow measuring device, which determines a flow of the blowing air from a compressed-air reservoir to the valve block 90 of a shaping station 4. Preferably, corresponding flow measuring devices are arranged in each case between a compressed-air reservoir and all shaping stations.

Further flow measuring devices can also be assigned between the further compressed-air reservoirs and the corresponding shaping stations.

Furthermore, position detecting devices are preferably also provided, which can detect positions of the stretching rods of the individual shaping stations.

Reference sign 24 designates a control device, which controls and, in particular, regulates the apparatus 1. This control device is preferably also able to change working parameters of the apparatus.

In particular, the control device controls the individual valves and thus the application of the individual pressure levels to the plastic preforms. In addition, the control device preferably also controls a movement of the stretching rods of the individual shaping stations. Preferably, the control device also controls movements of the application devices, i.e., the blowing nozzles. The control device is therefore preferably suitable for controlling and, in particular, also changing the time points at which the application devices are placed on the plastic preforms and/or the time points at which the blow molding devices are again lifted from the plastic preforms.

Reference sign 26 designates a storage device, in which, in particular, measured variables are stored, in particular pressure values and flow values, but also corresponding working parameters. Preferably, these respective values are stored with a temporal assignment.

Preferably, these values can be stored continuously and in particular over long periods of machine operation. The control device controls or regulates the apparatus, also taking into account these recorded measured values.

Reference sign 28 roughly schematically designates an inspection device for inspecting the manufactured containers. Preferably, an assignment device is also provided, which is suitable and intended to assign the working parameters used to manufacture a particular inspected container to this container.

Reference sign 25 designates a display device, which is used to output information to a machine operator. This display device can be used to output measured pressure (course) curves, for example.

FIGS. 2a-2c show an embodiment of the invention with an enlarged annular channel. Here, FIG. 2a shows the situation according to the prior art, in which a conventional annular channel 2a is provided.

In the situation shown in FIG. 2b, it can be seen that the volume of the annular channel 2a, which represents the compressed-air reservoir for the P1 pressure level, is greatly increased. In this manner, the effects of pressure fluctuations can be reduced. In the situation shown in FIG. 2c, a second annular channel 3a is provided in addition to the annular channel 2a. Several flow connections, in particular throttles 5, are provided between the two annular channels.

The embodiments according to FIGS. 2b and 2c are based on the idea that the annular channel is used as a kind of compressed-air storage and that, due to an increased volume, smaller flow differences of the receiving shaping stations 4 or cavities have less influence on the pressure in the annular channel. The increased volume smooths out these differences.

In the situation shown in FIG. 2c, as mentioned, an additional P1 annular channel 3a is provided and here a plurality of connecting lines with adjustable throttle 5, through which the pressure fluctuations can be reduced. Smaller pressure differences can be filled or released through this additional annular channel 3a without the need to open a dome pressure regulator 30, which introduces increased pressure fluctuations into the annular channel.

Various configurations with regard to the installation location of the dome pressure regulator 30 and the connection positions of the connections 5 of the ring lines can prove to be expedient.

FIG. 3 shows a representation of a pressure curve DK over time. The left-hand coordinate shows the pressure in bar, while the right-hand side shows a force in Newtons and a stretching rod position in millimeters.

Reference sign RK designates a stretching curve or a stretching rod movement. Reference signs I-IX show different states during the expansion process. Reference sign I designates the start of the blowing process with the pre-blowing. At time point II, the application of an intermediate blowing pressure is activated and at reference sign III, a final blowing pressure is activated. At time point IV, the pressure in the container has reached its maximum value and at time point V, the valve that feeds the final blowing pressure is closed again.

Reference sign Sv1 designates a switching time point or switching of an intermediate blowing valve, and reference sign Sv2 designates a switching time point or switching of the P2 valve. At time point V, the P2 valve is closed again.

At time point VI, the pressure in the container drops sharply as a result of a further opening of valve SV1 in order to initiate a recycling process.

At time point VII, this valve is closed again, thus completing the recycling. From time point VIII, the (complete) relief of the now formed container begins, which is completed at time point XI. The pressure measured at time point VIII allows conclusions to be drawn about the air consumption in standard processes.

FIG. 4 shows a representation illustrating an improved control of a stretching rod 82. It can be seen that the stretching rod here is first fully inserted into the plastic preform and is already used to stretch it. In the fourth partial image, valve P1 is opened and pre-blowing is started. In this state, the stretching rod touches the bottom of the plastic preform.

Within the scope of the invention, it is now proposed to adjust this stretching start in such a manner that a constant time elapses between the pressure build-up of the blowing curve and the stretching start, in particular across all shaping stations. As can be seen in FIG. 4, the first step here is to start with stretching and only then apply the pre-blowing pressure.

FIG. 5a-5c illustrate measures for valve switching. In each case, reference sign 42 refers to electrical switching signals for switching the valves, as does reference sign 44. In FIGS. 5b and 5c, reference sign 43 designates a mechanical position of the valve, for example a first valve, and reference sign 45 designates a mechanical position of a second valve. It can be seen that certain dead times occur in each case.

FIGS. 5b and 5c show the switching and pressure build-up times of the pre-blowing valve and an intermediate blowing valve. These valves are switched to ensure that the pressure build-up in the container is as energy-efficient as possible.

As shown in FIG. 5a-5c, there are certain rules for switching the pre-blowing pressure to the intermediate blowing pressure. First, an electrical signal 42 is output, which causes valve P1 to close. A certain dead time point then occurs. The valve Pi1 is then opened with a further electrical signal.

The dead time “t_{dead time}” shown is a fixed time, which is generally maintained regardless of the wear or an actual switching time of the corresponding valves.

In a preferred embodiment of the method according to the invention, this valve overlap time or dead time can be checked and possibly improved by means of a sensor system. With ideal process control, a switching curve could look like that shown in diagram 5b. In this case, it would be impossible for the higher pressure level to flow back into the lower pressure level.

In reality, however, wear or a process-related change may result in a change in the mechanical switching time of the valves, and this would result in overlapping valves beyond a reasonable extent, as shown in FIG. 5c.

Preferably, a sensor system in the annular channel or between the annular channel and the valve block could be used to detect an inflow of the higher pressure level into the annular channel and to set the dead time to an optimum with regard to air consumption and P2 high-pressure phase and, in particular, to set it automatically.

FIGS. 6a and 6b illustrate this situation. The annular channels 2A are again represented, as is the valve block 90. The aforementioned sensor system can be arranged between these devices.

In the prior art, a pressure level is currently switched after an adjustable time. However, in the gradient of the pressure curve or pressure graph, automatic switching of the next pressure stage would also be possible, for example after reaching a specified proportion of the annular channel pressure in the blowing curve. In this manner, the adjustment process could be simplified and, at the same time, different switching times and thus different pressures could be compensated.

As mentioned above, the time point at which the P2 pressure in the container is to be reached (in particular the delta from points II and IV in FIG. 3 can preferably be used by the regulation for the optimal air consumption.

At point V, as shown above, the P2 valve could close early, thus favorably making leakage detection possible. Extensive experiments have shown that a certain pressure peak is necessary to achieve a very good shape of the container. The holding pressure, which is necessary to press the container against the cold mold and to ensure cooling, has a certain level that should not be fallen below. However, this level is far below the mentioned pressure peak.

It has also been shown that, despite several recycling stages, air consumption is still very much dependent on how much P2 pressure (final blowing pressure) has to be used for the container.

For these reasons, the preferred approach is to reduce the pressure peak when building up the P2 pressure thereafter (i.e., in the pressure holding phase), in order thus to minimize air consumption.

FIG. 7 shows a further representation of the reduction in pressure consumption. Here, too, the pressure course over time is shown in simplified form. A maximum pressure Pₚₑₐₖ and a minimum pressure Pₘᵢₙ can be seen here. Furthermore, it can be seen that the pressure fluctuations in this range of the high pressure decrease over time.

In a preferred method, the time point at which the P2 pressure is to be reached in the container is set and, in particular, set automatically. Preferably, for this purpose, the delta from points II and IV is used by the regulation to determine the maximum or optimal air consumption.

In a preferred method, the P2 valve is closed when the pressure fluctuates only minimally. This is achieved in FIG. 7, approximately in the right-hand range of the pressure course. Due to the dynamics of the fluid as it flows into the container with abrupt deceleration of the fluid flow at the mold wall in the event of successful shaping, fluctuations in the pressure course occur in the first phase of the final blowing pressure application. Thus, if the pressure course has fewer fluctuations, this can be interpreted as a sign that the container is now fully formed and stabilized.

It would therefore be possible to use the pressure course at a pressure sensor to recognize that forming of the container is now completed, so that the P2 valve can be closed again at this moment, for example.

Preferably, the P2 valve is also closed early to detect leaks. If containers were to burst, air would escape and the pressure would fall below an adjustable minimum. Such containers can thus be detected and ejected.

In a further preferred method, the P2 valve is closed in a valley of the pressure fluctuation. In this case, the effective P2 pressure for this container can be minimized and the air consumption reduced.

Within the scope of the invention, it is further preferably proposed to find a minimum and to automatically close the valve in this range after an adjustable holding time.

Preferably, however, it is provided that a minimum holding time, in which the P2 pressure level is applied to the plastic containers, is not fallen below. This time is necessary in particular to maintain the dimensional stability of the plastic container.

In a further preferred method, the stretching rod is retracted at the earliest when the P2 valve is closed. In this manner, a lower air consumption can be achieved while maintaining the shape.

The effect of closing the P2 valve at this minimum of the pressure fluctuation can be further increased if the stretching rod returns to the zero position after the P2 valve closes. The air displaced by the stretching rod causes the pressure to drop during the holding phase.

If the stretching rod were to be retracted before the P2 valve closes, a dome pressure regulator would actively readjust and feed fresh air in order to replace the displaced volume with compressed air.

Preferably, the stretching rod is therefore retracted automatically only after the P2 valve closes or is closed, in order to reduce air consumption.

Preferably, however, the automatic control is also limited here to the extent that a minimum holding time is maintained during which the P2 pressure remains stored in the container.

It would be particularly advantageous to retract the stretching rod only after all pressure stages and also all recycling stages have been completed, in order to achieve a higher recycling potential and to provide more compressed air for the recycling processes more quickly. In this case, it would also be conceivable to return the stretching rod to the zero position in parallel with relieving. This would result in faster relieving and in a quicker and more effective recycling process.

There is also further potential for the recycling process at point 6 shown in FIG. 3. This time point can be determined by calculating back from a relief time point or a relief pressure (a forced relieving).

Preferably, control via a feedback angle or a time is also possible. Preferably, a pressure control and a time control are proposed here in order to achieve a minimum air consumption and a low fluctuation in the P1 compressed-air reservoir. Preferably, each control or regulation independently controls the necessary feedback angle and the necessary pressure level.

In a further preferred method, an automated offset setting via a calibration or setting run is suggested. This allows the 0° recycling angle and the target and actual pressure of a pressure reservoir to be adjusted.

In order to be able to adjust the air recycling system as precisely as possible, an offset should be adjusted beforehand. This offset indicates the extent to which the target and actual values of the annular channel pressure differ under production conditions when recycling the pre-blowing and intermediate blowing pressures.

For this purpose, the regulator factor should be set to 0% and the state should be set to manual mode, and, during ongoing production, the actual value should be compared with the target value. If the difference is greater than a specified tolerance range, such as +/−0.1, the offset values should be adjusted.

Preferably, the state is then set to automatic and the regulator factor is set above 0% again. Preferably, this is checked before the recycling system is activated.

Since these procedures are always the same and an incorrect choice of the offset has a greater influence on air consumption, it is advantageous to adjust this offset via regular calibration runs (for example, once a month or when loading a new recipe). For this purpose, the regulation of an air recycling is briefly switched off, the actual and target values of a pressure sensor are compared with each other, and an offset is adjusted in the case of deviations.

Further potential for compressed-air savings can be found in point VII in FIG. 3, i.e., the start of recycling for pressure stage P1. It is proposed here that the recycling start is carried out according to an optimal overlap between recycling and a simultaneous air discharge (of another shaping station) in order to reduce pressure fluctuations.

This is illustrated in FIG. 8. In a system with several shaping stations, for example eight shaping stations in FIG. 8, compressed air is fed into the longitudinally stretched plastic preform, for example from a pre-blowing annular channel 2a, at a certain angle or time point, and the pressure in the annular channel 2a decreases. In another shaping station, for example station 4′ in the figure, air is pressed into the annular channel 2a at a certain time point during recycling and the pressure in this annular channel 2a increases again. The resulting pressure fluctuations are represented in FIG. 9a.

In the prior art, these time points can be selected independently of each other or result from the process-related setting parameters. By carefully adjusting the feedback time point during air recycling, the pressure fluctuation can be minimized (cf. FIG. 9b) and the pressure in the annular channel P1 can be better maintained by simultaneously recycling and applying pressure to the plastic preform.

This procedure has also proven itself in extensive experiments conducted by the applicant.

This procedure has direct process-related advantages with regard to the material distribution of the container since the P1 pressure in the annular channel 2a has a significant influence on the container quality and small fluctuations in the annular channel 2a also reduce the fluctuations in the material distribution.

In a preferred method, pressure fluctuations in at least one compressed-air reservoir and in particular in the P1 compressed-air reservoir are therefore minimized by purposefully controlling a time point for a recycling process. This is represented here in FIG. 9b.

In a further preferred method, a feedback angle or a feedback time is controlled. Both pressure control and time control are possible. This also minimizes compressed-air consumption.

In a further preferred method, a setting run is carried out, for example before starting operation, in order to set offsets and, if necessary, limit values. In particular, an automated offset setting is preferably carried out via a setting run. A 0° recycling angle and target and actual values can be adjusted with regard to the pressures of the compressed-air reservoir.

In a further preferred method, a relief pressure is set. In methods known from the applicant's internal prior art, a relief time point at which the remaining compressed air is relieved from the container is set as a process-related variable and the pressure prevailing in the cavity, i.e., the blowing mold, at this time point and the time point result in a forced relief pressure which prevails when the application device is lifted.

A later relief time point would result in a longer high-pressure phase but could lead to too high a forced relief pressure due to process-related changes (e.g., a higher pressure in the cavity with a changed recycling setting) and the apparatus could even suffer mechanical damage.

However, since a relief time point should be selected as late as possible in order to keep the high-pressure phase as long as possible, it is proposed to select the maximum relief pressure as a process-related variable and to carry out an automated regulation of the time point.

The present invention facilitates the machine operation of such apparatuses and can also be carried out more easily by less trained personnel.

Furthermore, it results in lower air consumption, in particular while maintaining the container quality. In addition, errors are also minimized.

Furthermore, the method described also allows the introduction of a further intermediate blowing pressure. Finally, an improved automation concept is also presented.

The applicant reserves the right to claim all features disclosed in the application documents as essential to the invention, provided that they are novel over the prior art individually or in combination. It should also be noted that the individual figures also describe features which may be advantageous in their own right. The person skilled in the art will immediately recognize that a particular feature described in a figure can be advantageous even without the adoption of further features from this figure. Furthermore, the person skilled in the art will recognize that advantages can also result from a combination of several features shown in individual figures or in different figures.

1. A method for shaping plastic preforms into plastic containers, wherein a transport device transports the plastic preforms along a specified transport path, and the transport device has a preferably rotatable transport support, on which a plurality of shaping stations is arranged, wherein these shaping stations each have blow molding devices, within which the plastic preforms are shaped into the plastic containers by applying a flowable medium, and wherein at least three different pressure stages are applied to the plastic preforms in order to expand them, wherein these pressure stages are provided by at least three different compressed-air reservoirs, and wherein, additionally, the plastic preforms are stretched in their longitudinal direction by stretching rods, wherein
at least at times, compressed air is returned from the plastic containers to at least one compressed-air reservoir and at least one value characteristic of the consumption of compressed air is detected.

2. The method according to claim 1, wherein
the characteristic value is a measured flow rate, a current relief pressure or a difference between the highest intermediate blowing pressure and the final blowing pressure.

3. The method according to claim 1, wherein
the pressure course is recorded during the production of the plastic containers and, preferably, this pressure course is evaluated.

4. The method according to claim 1, wherein
on the basis of the evaluation of the pressure course, at least one working parameter, in particular a type-2 working parameter, for the expansion of the plastic preforms and/or for the pressure build-up and/or recycling is changed, in particular in order to reduce the consumption of compressed air.

5. The method according to claim 1, wherein,
after the type-1 process parameters have been entered, an apparatus suggests the type-2 process parameters to an operator.

6. The method according to claim 1, wherein
the type-2 process parameters are determined and/or set in part or completely by an apparatus.

7. The method according to claim 1, wherein
a determination of the type-1 and/or type-2 parameters is carried out on the basis of a model with or without AI.

8. The method according to claim 1, wherein
a determination of the type-1 and/or type-2 parameters is carried out by regulation or iteratively.

9. The method according to claim 1, wherein
a determination of the type-1 and/or type-2 parameters is carried out on the basis of a model with or without AI and by regulation.

10. The method according to claim 1, wherein
the working parameter is selected from a group of working parameters consisting of a pressure build-up time of a pressure level, in particular an intermediate blowing pressure level, a distribution of a pressure build-up time, a ratio between a recycling time and the pressure build-up time, a distribution of recycling times, a deviation from synchronicity, a way of operating recycling stages, a start of a stretching process, a stretching speed, a throttle cross-section of a valve device, in particular of a pre-blowing valve, a time point at which valve devices open and/or close, a target pressure of a pressure level, and a time point of retracting the stretching rod.

11. The method according to claim 1, wherein
a change is made taking into account targets, wherein these targets are preferably selected from a group of targets consisting of minimizing the relief pressure and/or the air consumption, maximizing a high-pressure phase and minimizing a pressure build-up time and minimizing the pressure fluctuation of a pressure level.

12. The method according to claim 1, wherein
a specific parameter is changed within a specified range and the effect of this change is detected.

13. The method according to claim 1, wherein
at least four different pressure levels are applied to the plastic preforms.

14. The method according to claim 1, wherein
at least one characteristic value for a compressed-air consumption and/or a compressed-air course is visualized.

15. An apparatus for shaping plastic preforms into plastic containers, comprising a transport device configured to transport the plastic preforms to be shaped along a specified transport path, wherein the transport device has a preferably rotatable transport support, on which a plurality of shaping stations is arranged, wherein these shaping stations each have blow molding devices, within which the plastic preforms are shaped into the plastics containers by applying a flowable medium, and the shaping stations each have application devices in order to apply the flowable medium to the plastic preforms, wherein the shaping stations each have stretching devices configured for stretching the plastic preforms in their longitudinal direction, and these stretching devices each have at least one stretching rod, which is movable in the longitudinal direction of the plastic preforms and is configured to be inserted into the plastic preforms, and wherein the apparatus has at least three compressed-air reservoirs configured to apply at least three different pressure levels to the plastic preforms,
wherein
compressed air can be returned at least at times from the shaping stations to at least one compressed-air reservoir and a detection device, which detects, at least at times, a value characteristic of the consumption of compressed air, is provided.

16. The apparatus according to claim 15, wherein
the apparatus has a control device, which is configured to control the apparatus taking into account a detected consumption of compressed air.

17. The apparatus according to claim 16, wherein
the control device is configured to change working parameters for the shaping process and, in particular, to change them taking into account a detected consumption of compressed air.

18. The apparatus according to claim 17, wherein
one of the compressed-air reservoirs has a larger holding volume for compressed air than the other compressed-air reservoirs and/or at least two compressed-air reservoirs that are configured to be brought into direct flow connection with one another are available.

19. The apparatus according to claim 18, wherein
the apparatus has a control device, which changes is configured to change at least one process parameter on the basis of measured pressure courses.

20. The method according to claim 2, wherein
on the basis of the evaluation of the pressure course, at least one working parameter, in particular a type-2 working parameter, for the expansion of the plastic preforms and/or for the pressure build-up and/or recycling is changed, in particular in order to reduce the consumption of compressed air.
